(19) United States
(12) Patent Application Publication
(10) Pub. No.: US 2024/0173794 A1
(43) Pub. Date: May 30, 2024

(54) METHOD FOR PRODUCING A FLAT, FLEXIBLE COMPOSITE MATERIAL, AND CORRESPONDING FLAT, FLEXIBLE COMPOSITE MATERIAL

(71) Applicant: NUO GmbH, Karlsruhe (DE)

(72) Inventors: Marcello ANTONELLI, Rome (IT); Marta ANTONELLI, Rome (IT)

(73) Assignee: NUO GmbH, Karlsruhe (DE)

(21) Appl. No.: 18/432,834

(22) Filed: Feb. 5, 2024

Related U.S. Application Data
(63) Continuation of application No. PCT/EP2022/068839, filed on Jul. 7, 2022.

(30) Foreign Application Priority Data
Aug. 3, 2021 (DE) 10 2021 120 097.0

(51) Int. Cl. B23K 26/06; B23K 26/042; B23K 26/08; B23K 26/364; B23K 26/402; B23K 103/00; B23K 103/16

(52) U.S. Cl. CPC B23K 26/0608; B23K 26/042; B23K 26/0838; B23K 26/364; B23K 26/402; B23K 2103/172; B23K 2103/36

(57) ABSTRACT

A method for producing a planar resilient composite material which has a carrier layer of a textile material and a cover layer of wood veneer which is connected to the carrier layer. A groove structure is engraved in the wood veneer of the cover layer via laser engraving. The structure to be engraved is established and imported into a control apparatus of a laser engraving device, the composite material is placed on a worktable, and a laser head connected to the control apparatus is activated so as to engrave the structure in the wood veneer of the cover layer. At least two laser heads of the laser engraving device are activated so as to, via the laser beam of a respective laser head, engrave the structure simultaneously in adjacent regions of the wood veneer of the cover layer of the composite material that are assigned to a respective laser head.

This nonprovisional application is a continuation of International Application No. PCT/EP2022/068839, which was filed on Jul. 7, 2022, and which claims priority to German Patent Application No. 10 2021 120 097.0, which was filed in Germany on Aug. 3, 2021, and which are both herein incorporated by reference.

### BACKGROUND OF THE INVENTION

### Field of the Invention

The invention relates to a method for producing a planar resilient composite material which has a carrier layer of a resilient material, in particular in the form of a textile material, and a cover layer of wood veneer which is connected to the carrier layer and is more rigid in comparison to the latter, wherein a structure configured in the form of a plurality of grooves is engraved in the wood veneer of the cover layer by means of laser engraving, so as to increase the resilience of the wood veneer of the cover layer, comprising the following method steps: establishing the structure to be engraved in the wood veneer of the cover layer, and importing the structure into a control apparatus of a laser engraving device specified in programming terms; arranging the composite material on a worktable of the laser engraving device in such a manner that the wood veneer of the cover layer of the composite material is located on the side facing away from the worktable; and activating at least one laser head of the laser engraving device that is connected to the control apparatus, and engraving the structure in the wood veneer of the cover layer of the composite material by means of the laser beam generated by the laser head.

The invention furthermore relates to a planar resilient composite material which is produced in such a manner and has a carrier layer of a resilient material, in particular in the form of a textile material, and a cover layer of wood veneer which is connected to the carrier layer and is more rigid in comparison to the latter, wherein the wood veneer of the cover layer has a structure configured in the form of a plurality of grooves and is engraved by means of laser engraving.

### Description of the Background Art

Composite materials are known and comprise, on the one hand, a carrier layer of a resilient material which is usually formed by a textile material such as a woven fabric, knitted fabric, scrim, warp and/or weft knitted fabric, non-woven fabric or the like. The cover layer, which is more rigid in comparison to the latter, serves as a decorative layer and is composed predominantly of wood materials, in particular of genuine wood veneer which may have a thickness, for example, between approximately 0.1 mm and approximately 1 mm, in particular between approximately 0.25 mm and approximately 0.75 mm, and is typically adhesively bonded to the carrier layer, wherein the cover layer, for example, is laminated onto the carrier layer while disposing therebetween an adhesive layer. The wood veneer of the cover layer is provided with a structure, configured in the form of a plurality of grooves, which is engraved in the wood veneer by means of laser engraving and is intended to impart an aesthetic overall appeal to the cover layer, on the one hand, and, on the other hand, serves in particular for increasing the resilience of the wood veneer of the cover layer that is more rigid in comparison to the textile carrier layer. The wood veneer of the cover layer, and consequently the entire composite material herein, is imparted an extraordinarily high degree of resilience, similar to that of leather or textile materials, by the fine laser engraving while nevertheless maintaining a very high degree of mechanical strength, so that a generic composite material is an ideal choice for a multiplicity of fields of application such as, for example, garments, as a decorative material for not necessarily flat visible surfaces of items of furniture, housings, or vehicle interior trim parts, for covering seating furniture, for curtains, drapes, wall coverings, ceiling coverings, floor coverings, etc.

EP 2 776 240 B1, which corresponds to US 2015/0050454, describes a generic method for producing a planar resilient composite material having a carrier layer of a textile woven fabric and a cover layer of wood adhesively bonded to the latter, wherein the wood veneer of the cover layer of the prefabricated composite material is provided with the desired structure of a uniform groove pattern by means of laser engraving.

However, it has been demonstrated in practice that, in particular, the application of the structure of the wood veneer of the cover layer, which is in the form of a plurality of grooves, by means of laser engraving represents a significant technical challenge because, for aesthetic reasons as well as with a view to a high degree of mechanical stability of the composite material, the grooves of the structure that are engraved in the wood veneer should have an ideally uniform but very minor width, preferably, for example, in the range from approximately 10 μm to approximately 100 μm, as well as an ideally uniform depth, so as to cut through the wood veneer of the cover layer at least in part or substantially completely, whilst the carrier layer is to remain substantially intact. Moreover, the groove structure should extend substantially uniformly, with high precision, across the entire area of the wood veneer of the cover layer without production-related faults being visually identifiable.

For a plurality of reasons, the aforementioned requirements cannot be satisfactorily met to date, in particular as the dimensions of the wood veneer of the cover layer increase. For instance, attempts have been made to displace the laser head in a controlled micromechanical manner in programming terms across the width of the wood veneer of the cover layer, which has proven to be very complex in terms of construction as well as in terms of the energetic and temporal input. Instead, attempts have also been made to engrave the groove structure in the wood veneer of the cover layer by means of a galvanometric laser which is held stationary in relation to the composite material but has a mirror for deflecting the laser beam according to the desired structure and which is displaceable in a controlled manner in programming terms. While such a galvanometric laser head is significantly more efficient in comparison to a conventional laser head which is displaceable along a plane and is able to engrave the respective structure in the wood veneer of the cover layer in particular up to approximately 10 to 65 times faster, there is in this case the problem that, on the one hand, the galvanometric laser head cannot be disposed too close to the wood veneer of the cover layer because this results in a very oblique incidence angle of the laser beam in particular in the peripheral regions of a cover layer of a relatively large area, the oblique incidence angle consequently resulting in (excessively) wide and fuzzy grooves of the structure, the grooves now having an only minor depth of penetration into the cover layer, so that a uniform structure of high aesthetic quality cannot be maintained across the entire area of the cover layer, whereby there is moreover the risk that the laser head is contaminated due to local evaporation of the organic material of the cover layer and requires frequent cleaning, this leading to regular occurrences of downtime of the laser engraving devices. On the other hand, the galvanometric laser head can also not be disposed too far from the wood veneer because, apart from an increased energetic input to compensate for the dissipation of energy as the length of the beam increases, it is in this case in particular not possible to incorporate the structure in the form of very fine grooves precisely into the wood veneer of the cover layer, because the laser beam fans out, or widens, as the length of the beam increases.

Moreover laser engraving devices having a plurality of laser heads are known for other application purposes, wherein, for example, a laser engraving device having two galvanometric laser heads can be derived from DE 196 34 190 A1, which corresponds to U.S. Pat. No. 6,180,913 (which is incorporated herein by reference), the laser beams thereof, by means of mirrors that are displaceable in a controlled manner, being able to be focused simultaneously but independently of one another onto different working regions of a workpiece so as to provide the workpiece with an inscription at different locations. However, the application of a largely uniform structure to the wood veneer of the cover layer of a generic composite body in this way is, if at all, possible only with limitations because it has been demonstrated that the transition between the structure portions generated by the laser beam of a respective laser head is readily visible and, therefore, cannot meet the aesthetic requirements. The same applies in an analogous manner to a laser engraving method known from US 2010/0272961 A1 (which is incorporated herein by reference), for generating a structure formed from a plurality of lines, which may comprise the use of two lasers having in each case one working region assigned to a respective laser.

### SUMMARY OF THE INVENTION

It is therefore an object of the invention to provide a method for producing a planar resilient composite material of the type mentioned at the outset in a simple and cost-effective manner, while at least largely avoiding the aforementioned disadvantages, with a view to engraving a uniform and homogenous structure across the entire area of the wood veneer of the cover layer, even of composite materials with a large area, being possible in a temporally as well as energetically efficient manner and with very high precision. The invention is furthermore directed towards a composite material of the type mentioned at the outset produced in such a manner.

In terms of the method, this object in a method of the type mentioned at the outset is achieved according to the invention in that at least two laser heads of the laser engraving device that are connected to the control apparatus are activated so as to, by means of the laser beam of a respective laser head, engrave the structure simultaneously in adjacent regions of the wood veneer of the cover layer of the composite material that are assigned to a respective laser head, wherein the laser heads in programming terms are controlled in such a manner that in a first overlapping portion of the adjacent regions of the composite material the structure is engraved in the wood veneer of the cover layer randomly in part by the laser beam of the one laser head and in part by the laser beam of the other laser head.

In terms of the product, the invention for achieving this object furthermore provides a planar resilient composite material which is produced by means of such a method and has a carrier layer of a resilient material, in particular in the form of a textile material, and a cover layer of wood veneer which is connected to the carrier layer and is more rigid in comparison to the latter, wherein the wood veneer of the cover layer has a structure which is configured in the form of a plurality of grooves and is engraved by means of laser engraving.

Consequently, the invention provides that—once the planar composite body has been connected by connecting, such as adhesively bonding, for example, the textile carrier layer to the not yet engraved wood veneer of the decorative cover layer—the desired structure is first established, e.g. by means of a suitable CAD program and imported into the control apparatus, or into a storage unit of the laser engraving device specified in programming terms, as is known per se from EP 2 776 240 B1, which corresponds to US 2015/0050454, which is incorporated herein by reference. As is likewise known therefrom, the composite material prefabricated in this manner is then placed on the worktable of the laser engraving device in such a manner that the wood veneer of the cover layer of the composite material is located on the side facing away from the worktable and in this way is exposed to the laser heads connected to the control apparatus of the laser engraving device. Thereafter, the laser heads of the laser engraving device are activated so as to engrave the respective structure in the form of grooves in the wood veneer of the cover layer of the composite material by means of the laser beam generated by a respective laser head.

The invention herein provides that the at least two laser heads connected to the control apparatus, by means of the laser beam of a respective laser head, engrave the structure simultaneously in adjacent regions of the wood veneer of the cover layer of the composite material that are assigned to a respective laser head, wherein in the case of two laser heads, the one laser head engraves the structure in a lefthand longitudinal region of the cover layer, for example, while the other laser head simultaneously engraves the structure in a righthand longitudinal region of the cover layer in such a way that temporally efficient engraving of the structure is possible while at the same time offering high precision, because the laser heads can be disposed at a respective optimal spacing from the wood veneer of the cover layer, and the length of the beam as well as the incidence angle of the laser beams of both laser heads, or all laser heads, can be chosen to be very similar in such a way that a uniform and homogeneous structure of highest precision is derived across the entire area even of planar composite bodies with a large area.

In order to prevent that the regions of the wood veneer of the cover layer engraved by different laser heads are visible due to even only minor discontinuities of the structure in the transition region of these regions, and in this way impair the aesthetic overall appeal and/or cause any change in the resilience of the composite body in regions, the invention provides in particular that the laser heads in terms of programming are controlled in such a manner that in a first overlapping portion of the adjacent regions of the composite material the structure is engraved in the wood veneer of the cover layer randomly in part by the laser beam of the one laser head and in part by the laser beam of the other laser head. Consequently, according to the invention, the regions of the composite body processed by a respective laser head of the laser engraving device are not in each case assigned to a fixed and unchanging, mutually adjacent working region of a respective laser head, but the adjacent working regions of a respective laser head overlap in the first overlapping portion in which the structure is engraved in the wood veneer of the cover layer randomly in part by the laser beam of the one laser head and in part by the laser beam of the other laser head. No sharp border between the working regions of the laser heads, and consequently also no visible transition between the regions of the cover layer processed by different laser heads, results in this way, wherein the first overlapping portion may preferably have a width between, for example, approximately 2 mm and approximately 50 cm, in particular between approximately 5 mm and approximately 25 cm.

An algorithm suitable for the random assignment of the one or the other laser head for engraving the structure in the wood veneer of the decorative layer in the first overlapping portion can expediently be stored in the control software of the control apparatus of the laser engraving device, wherein the width of the first overlapping portion can preferably be adjustable, for example by means of a customary input device such as a keyboard, a touchscreen or the like, so as to be able to optionally adapt the width to the respective configuration of the desired structure.

If the structure is engraved in the wood veneer of the cover layer in the form of grooves which at least in part extend between two adjacent regions of the composite material that are assigned to a respective laser head, as is usually the case in generic planar composite bodies, the initial points and/or final points of the grooves generated by means of the laser beam of the one laser head and the final points and/or initial points of the grooves generated by means of the laser beam of the other laser head in the first overlapping portion can be randomly established. Those grooves of the structure that extend from the region processed by one of the laser beams beyond the first overlapping portion into the adjacent region of the wood veneer of the cover layer processed by another laser beam consequently have in the first overlapping portion initial points and/or final points which are arranged so as to be randomly offset and starting from which the laser beam of the one laser head, or up to which the laser beam of the other laser head, has engraved the respective groove in the wood veneer of the cover layer.

As has already been mentioned, the method according to the invention, owing to its high precision in terms of the laser beams of the laser heads that act on the wood veneer of the cover layer at very similar angles, makes it possible that the structure engraved in the wood veneer of the cover layer in the form of a plurality of grooves is engraved in such a manner that the carrier layer remains substantially intact, whereas the wood veneer of the cover layer is at least in part or substantially completely cut through. The wood veneer of the cover layer should advantageously be at least largely cut through in the process, i.e. in particular up to at least approximately 70% of its depth, preferably up to at least approximately 80% of its depth, most preferably up to at least approximately 90% of its depth, or else substantially completely cut through in such a way that the composite material can be imparted a very high degree of resilience while at the same time maintaining a high degree of mechanical stability.

It can furthermore be provided that the worktable of the laser engraving device with the composite material, can be displaced past the laser heads in particular in a substantially continuous or semi-continuous manner, so as to engrave the structure successively in adjacent regions of the wood veneer of the cover layer, wherein the displacement direction of the worktable is chosen so as to be substantially parallel to the direction of extent of the first overlapping portion between the laser heads. In this way, very large-format webs of the composite material can be processed practically continuously in a very time-efficient manner, and tooling and/or retrieving times are minimized, wherein the composite material is expediently displaced successively in such a manner that the composite material is successively fed to the working regions assigned to a respective laser head and thereafter, once the structure has been engraved in the respective regions of the wood veneer of the cover layer, is displaced onwards so as to process the following working regions assigned to a respective laser head. Moreover, in this way it is conceivable, for example, to provide the carrier layer of textile material in the form of a continuous web, in that the latter is unwound from a roll, for example, whereupon the unwound continuous web is successively adhesively bonded to wood veneers of the cover layer, and the planer composite material, which has been substantially continuously prefabricated in this way, is fed to the laser heads by means of the successively displaced worktable so as to engrave the structure in the cover layer. The composite material, which is highly resilient after laser engraving, can finally be cut to length according to the desired dimensions, or again be wound on rolls in the form of a continuous material.

The displacement of the worktable herein in terms of programming can expediently be synchronized with the laser heads in that a drive of the worktable that is connected to the control apparatus of the laser heads displaces the worktable as a function of the processing state of the structure.

For this purpose, the worktable can have, for example, a slide which is suitable for receiving the composite material and is driven by the motorized drive and is guided past the laser heads along a guide, like a linear guide. Instead, the worktable can, for example, also comprise a belt conveyor, e.g. in the form of a revolving carrier belt, which is suitable for receiving the composite material and is driven by the motorized drive. Alternatively, it is conceivable, for example, that the worktable has a roller track which has a plurality of rolls or rollers disposed in parallel and is suitable for receiving the composite material, at least some of the rolls or rollers being rotationally driven by means of the motorized drive.

In conjunction with such a substantially continuous or semi-continuous feeding of the composite material to the laser heads, it is furthermore advantageous for a respective laser head in programming terms to be controlled in such a manner that, in a second overlapping portion, extending substantially perpendicularly to the displacement direction of the worktable, of adjacent regions of the composite material that are in each case assigned to the same laser head, the structure is engraved in the wood veneer of the cover layer by the laser beam of the respective laser head randomly before or after a displacement step of the worktable. In order to also prevent that the regions of the wood veneer of the cover layer that are disposed next to one another in the displacement direction of the worktable and are successively engraved in a temporal sequence by in each case one and the same laser head are visible owing to even only slight discontinuities of the structure in the transition region of these regions and in this way impair the aesthetic overall appeal and/or cause a change in the resilience of the composite body in regions, the invention accordingly provides that—in a manner analogous to the first overlapping portion formed between the working regions of adjacent laser heads—a respective laser head in programming terms is controlled in such a manner that, in a respective second overlapping portion, extending approximately perpendicularly to the displacement direction of the worktable, of the adjacent regions of the composite material, the structure is engraved in the wood veneer of the cover layer by the laser beam of the respective (same) laser head randomly in part before a displacement step of the worktable, and in part after a displacement step of the worktable. In this way, no sharp border between the regions of the wood veneer of the cover layer fed successively to the laser heads by means of the displaceable worktable, and consequently also no visible transition between the regions of the cover layer that are successively processed by a respective laser head, results in this way, wherein the second overlapping portion (like the first overlapping portion; see above) can preferably have a width between, for example, approximately 2 mm and approximately 50 cm, in particular between approximately 5 mm and approximately 25 cm.

If, as mentioned further above, the structure is engraved in the wood veneer of the cover layer in the form of grooves which at least in part extend between two adjacent regions of the composite material that are assigned to the same respective laser head, as is usually the case in generic planar composite bodies, the initial points and/or final points of the grooves generated by means of the laser beam of the respective laser head before a displacement step of the worktable, and the final points and/or initial points of the grooves generated by means of the laser beam of the respective laser head after a displacement step, in the second overlapping portion can again in particular be randomly established. Those grooves of the structure that extend from the region processed by a respective laser head before a displacement step of the worktable beyond the second overlapping portion into the adjacent region of the wood veneer of the cover layer processed by the same laser head after the displacement step, consequently also in the second overlapping portion have initial points and/or final points which are arranged so as to be randomly offset and up to which the laser beam of the respective laser head, or starting from which the laser beam of the same laser head, has engraved the respective groove in the wood veneer of the cover layer before or after a respective displacement step of the worktable.

In order to ensure at all times an exact, flat alignment of the composite material located on the worktable during processing by means of the laser heads, it can be provided according to an advantageous refinement that the composite material, at least while the structure is being engraved, is suctioned to the worktable. This can take place by means of arbitrary negative pressure generators known to one skilled in the art, e.g. in the form of pumps, which as a result of negative pressure press the composite material against the worktable, for example against the surface of the latter, against the carrier belt of the latter, or against the roller track of the latter.

As has already been mentioned, for the reasons mentioned further above, the laser engraving machine can advantageously have at least two stationary galvanometric laser heads which have at least one mirror and/or lens connected to the control apparatus, wherein the laser heads by means of the control apparatus are controlled in programming terms in such a manner that their mirrors and/or lenses are displaced in a manner corresponding to the structure to be engraved in the wood veneer of the cover layer. Galvanometric laser heads of this type are known per se from the prior art, such as from, for example, DE 196 34 190 A1, which corresponds to U.S. Pat. No. 6,180,913, which is incorporated herein by reference, and wherein the advantageous of the galvanometric laser heads lie predominantly in that the latter, owing to the fact that only the mirrors and/or lenses serving for the controlled deflection of the laser beams have to be movable, but the laser heads per se can be arranged so as to be stationary, are very time-efficient and cost-efficient and in particular do not require any complex mechanism for the translatory displacement of the laser head.

As has already been mentioned, by virtue of the plurality of laser heads, the spacing between the wood veneer of the cover layer and the laser heads can be adjusted to the optimal dimension even in the case of large-format composite bodies, so as to ensure that a structure with very narrow grooves is generated as a result of highly focused “short” laser beams, on the one hand, and to prevent, on the other hand, that constituent parts of the organic material of the cover layer, which are transferred to the vapor stage, are deposited on the laser heads and the latter require frequent cleaning, wherein the laser heads are preferably disposed at a spacing between, for example, approximately 10 cm and approximately 150 cm, in particular between approximately 30 cm and approximately 130 cm, preferably between approximately 50 cm and approximately 110 cm, from the surface of the wood veneer of the cover layer of the composite material.

If desired, the wood veneer of the cover layer after laser engraving can furthermore be provided with a lacquer layer so as to ensure that the surface of the wood veneer of the cover layer, which is most typically porous, is sealed while maintaining a very high-quality aesthetic overall appeal of the planar composite material.

A planar resilient composite material which has been produced by means of the method according to the invention can consequently have a structure which is generated in the wood veneer of the cover layer by means of laser engraving and which extends uniformly across substantially the entire area of the wood veneer of the cover layer, in particular even when the composite material has dimensions of a comparatively large format. The plurality of grooves of the structure engraved in the wood veneer of the cover layer herein can preferably at least in part or substantially completely cut through the wood veneer of the cover layer, whereas the carrier layer is in particular substantially intact, wherein reference is to be made to the explanations above. Moreover, the plurality of grooves of the structure engraved in the wood veneer of the cover layer can advantageously have a substantially uniform width and/or a substantially uniform depth in such a way that this results in a high degree of aesthetics in association with a uniform resilience across the entire area of the composite material, the resilience largely corresponding to that of conventional leather or textile materials. Moreover, the wood veneer of the cover layer can be provided with a lacquer layer if required, for example.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1a shows a schematic perspective view of a carrier layer and cover layer during prefabrication of a blank of the composite material, the carrier layer and cover layer forming the constituent parts of a composite material according to the invention;

FIG. 1b shows a schematic perspective view of an embodiment of a galvanometric laser head of a laser engraving device according to FIGS. 2 to 6 during engraving of a structure formed by a plurality of grooves in the cover layer of the composite material according to FIG. 1a;

FIG. 1c shows a schematic perspective view of an example of the resilient composite material after laser engraving according to FIG. 1b;

FIG. 2 shows a schematic perspective view of an example of a laser engraving device suitable for carrying out a method according to the invention;

FIG. 3 shows a schematic frontal view of the laser engraving device according to FIG. 2;

FIG. 4 shows a schematic lateral view of the laser engraving device according to FIGS. 2 and 3;

FIG. 5 shows a schematic view from above of the laser engraving device according to FIGS. 2 to 4;

FIG. 6 shows a schematic perspective detailed view of two galvanometric laser heads of the laser engraving device according to FIGS. 2 to 5 during simultaneous engraving of a structure formed from a plurality of grooves in the cover layer of the composite material;

FIG. 7 shows a schematic view from above of the wood veneer of the cover layer of a composite material, which wood veneer has been provided with a structure formed from a plurality of grooves by means of laser engraving, however without overlapping portions having been provided between the different regions processed by the respective laser heads; and

FIG. 8 shows a schematic view from above of four exemplary grooves of the structure engraved in the wood veneer of the cover layer by means of laser engraving using the laser engraving device according to FIGS. 2 to 6, which grooves extend beyond a first overlapping portion between two regions of the composite material generated by different laser heads of the laser engraving device.

### DETAILED DESCRIPTION

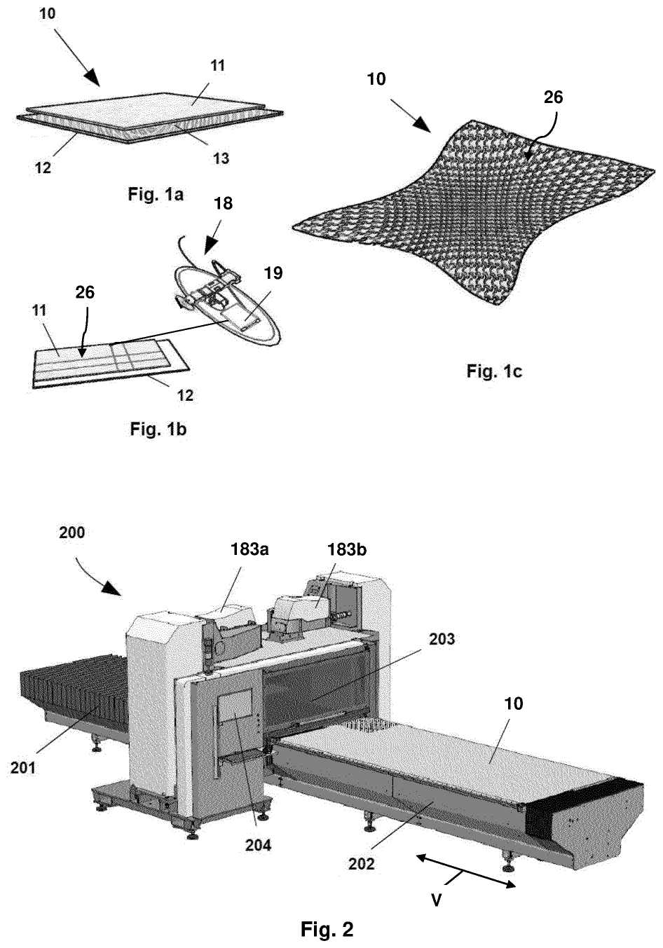

A situation during the prefabrication of a blank of a planar composite material which in its entirety is provided with the reference sign 10 is reproduced in FIG. 1a. The composite material 10 comprises a carrier layer 12 of a resilient material, such as a textile material, and a cover layer 11 of a decorative wood veneer, which is more rigid in comparison to the latter. In order to prefabricate the blank of the composite material 10, the carrier layer 12 is connected to the cover layer 11, which can take place, for example, by means of an adhesive layer 13 disposed between the carrier layer 12 and the cover layer 11.

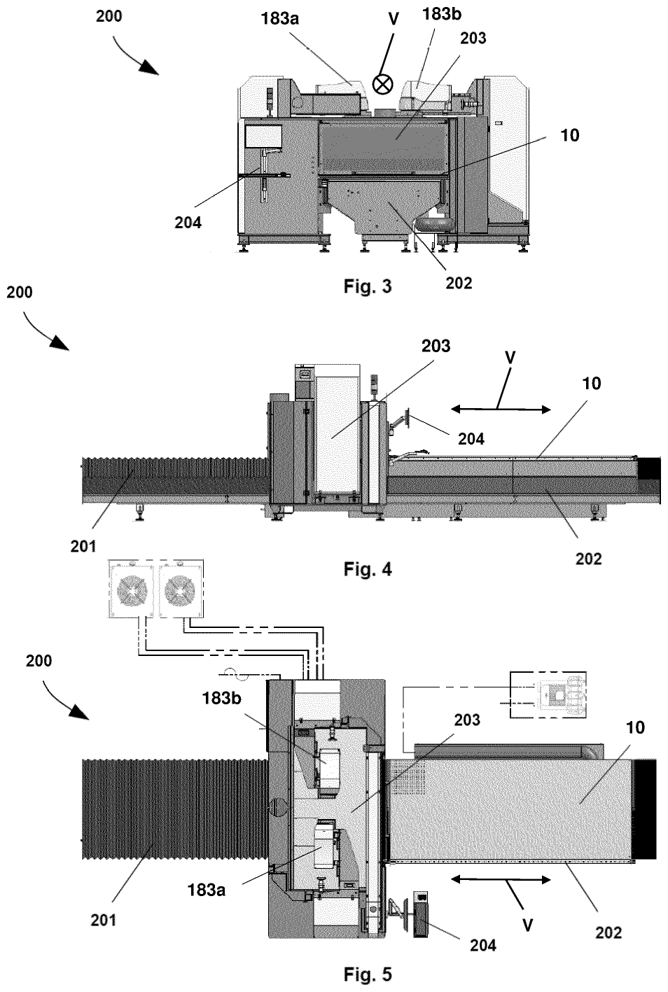

Schematically reproduced in FIG. 1b is an embodiment of one of the galvanometric laser heads 18 of a laser engraving device which is explained in more detail further below with reference to FIGS. 2 to 6, which laser head 18 serves for engraving a structure 26 formed from a plurality of grooves in the wood veneer of the cover layer 11 of the blank of the composite material 10 according to FIG. 1a, so as to increase the resilience of the wood veneer of the cover layer 11 and to impart the latter an aesthetically high-quality overall appeal. The laser head 18 in the present case is a galvanometric laser head 18 which is held so as to be stationary and which has a mirror 19 which is largely freely displaceable in the three-dimensional space so as to deflect the generated laser beam in the desired direction. The laser head 18, including a drive of its mirror 19, is operatively connected to a control apparatus of the laser engraving device (cf. FIGS. 2 to 6), so as to, by means of the control apparatus, be able to control the laser head 18 equipped with the displaceable mirror 19 in programming terms in such a manner that the mirror 19 is displaced in a manner corresponding to the structure 26 to be engraved in the wood veneer of the cover layer 11. Prior thereto, the respective desired structure 26 herein has been established by means of a suitable CAD program and imported into the control apparatus, for example.

FIG. 1c shows the finished planar composite material 10 which is henceforth very resilient, similar to known leather or textile materials, once the structure 26, which in the present case extends substantially uniformly across practically the entire area of the cover layer 11, has been engraved in the wood veneer of the cover layer 11 of the composite material 10 by means of laser engraving.

An embodiment of a laser engraving device, which in its entirety is provided with the reference sign 200 and in terms of programming is specified to automatically carry out the method according to the invention for producing the planar resilient composite material 10 according to FIG. 1c, is schematically reproduced in FIGS. 2 to 6. The laser engraving device 200 comprises a worktable 202 which in the present case is designed substantially in the manner of a slide and which is displaceable, in particularly approximately horizontally, in a controlled manner in the direction of the arrow V along a guide 201, in particular in the form of a linear guide, which worktable 202 serves for receiving an in particular relatively large-format, and for example substantially web-shaped, composite material to be processed, according to FIG. 1a, and is able to successively feed the composite material 10 to a laser processing region 203, on the one hand, and after the retrieval of a completely processed composite material according to FIG. 1c, is able to be displaced back in the opposite direction, on the other hand, so as to engrave a multiplicity of composite materials in a largely continuous or semi-continuous manner, and to enable an efficient large-scale production in the process. The surface of the worktable 202, which serves for receiving the composite material 10, can preferably be connected to a negative pressure generator so as to press the composite material 10 against the worktable during laser engraving and to ensure in this way an exact, consistent and reproducible alignment of the composite material in the laser processing region 203. A drive of the worktable 202 is connected to a control apparatus of the laser engraving device 200 and comprises a central data processing unit which in the present case is equipped with an input apparatus 204 so as enter and/or select a desired structure to be engraved in the cover layer 11 of the composite material 10, a desired processing program, etc. Moreover, the laser engraving device comprises a plurality of—here two—galvanometric laser heads 183a, 183b which are likewise connected to the control apparatus and are disposed so as to be stationary above the laser processing region 203 but are optionally height adjustable, and which are disposed at a mutual spacing disposed perpendicularly to the displacement direction V of the worktable 202, and in terms of construction correspond to that according to FIG. 1. For the sake of completeness it is however to be pointed out that the laser heads 183a, 183b do not necessarily have to be disposed perpendicularly to the displacement direction V of the worktable 202, but may also be disposed offset in relation to the latter, for example.

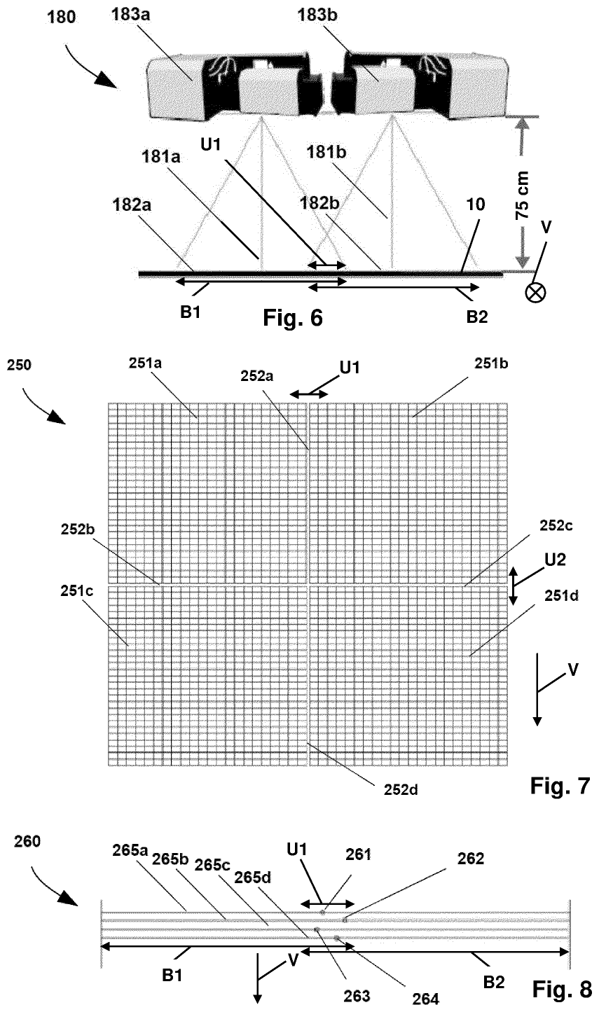

As can be derived in particular from FIG. 6, the laser heads 183a, 183b are disposed, for example, at a spacing of approximately 75 cm from the worktable 202, or the composite material 10 positioned thereon, respectively, and have the purpose of engraving the structure 26 (cf. FIG. 1c) simultaneously in adjacent regions B1, B2 of the wood veneer of the cover layer 11 of the composite material 10 that are assigned to the respective working region 182a, 182b of a respective laser head 183a, 183b by means of a respective laser beam 181a, 181b, which is deflectable by the displacement of the mirrors 19 of the laser heads 183a, 183b in a controlled manner in programming terms, wherein the laser heads 183a, 183b in programming terms are controllable according to the invention in such a manner that in a first overlapping portion U1 of the adjacent regions B1, B2 of the composite material 10 the structure 26 is engraved in the wood veneer of the cover layer 11 randomly in part by the laser beam 181a, 181b of the one laser head 183a, 183b and in part by the laser beam 181b, 181a of the other laser head 183b, 183a. According to the invention, the working regions 182a, 182b of the laser heads 183a, 183b, or the regions B1, B2 in which the structure 26 is engraved in the cover layer 11, are thus not stationary but overlap in the first overlapping region U1, in which parts of the structure 26 are engraved in the cover layer randomly by the laser beam 181a, 181b of the one or the other laser head 183a, 183b, so as to ensure, in particular in the case of a groove of the structure 26 that extends from the working region 182a of the one laser head 183a, or from the one region B1 of the cover layer 11, into the working region 182b of the other laser head 183b, or into the other region B2 of the cover layer 11 of the composite material 10, respectively, that a smooth, invisible transition which does not locally impair the material characteristics of the finished laser-engraved composite body 10, in particular not the resilience thereof, is generated.

In a similar manner, the laser heads 183a, 183b in programming terms are preferably controllable in such a manner that in a second overlapping portion U2 (cf. FIG. 7), extending substantially perpendicularly to the displacement direction V of the worktable 202 when the latter is incrementally displaced in the direction of the arrow V for the successive processing of the composite material 10, of adjacent regions of the composite material 10 that are in each case assigned to the same laser head 183a, 183b, the structure 26 is engraved in the wood veneer of the cover layer 11 by the laser beam 181a, 181b of the respective laser head 183a, 183b randomly in part before a displacement step of the worktable 202, and in part after a displacement step of the worktable 202. The working regions 182a, 182b of a respective laser head which are mutually contiguous in the displacement direction V of the worktable 202, or the regions B1, B2 which are mutually contiguous in the displacement direction V of the worktable 202, in which the structure 26 is engraved in the cover layer 11 are thus likewise preferably not stationary but overlap in the second overlapping portion U2 in which parts of the structure 26 are engraved in the cover layer by the laser beam 181a, 181b of the respective laser head 183a, 183b randomly before or after a respective displacement step of the worktable 202, so as to ensure that a smooth, invisible transition which does not impair the material characteristics of the finished laser-engraved composite body 10, such as in particular the resilience thereof, is generated in particular also in a groove of the structure 26 that extends beyond at least two displacement steps of the worktable 202.

Illustrated in FIG. 7 is a schematic view from above of a structure 250 of the wood veneer of a cover layer 11 of the composite material 10, which structure 250 has been generated by means of laser engraving while using two laser heads while incrementally displacing V a worktable, but without overlapping portions U1, U2 having been provided between the different regions 251a, 251b, 251c, 251d processed by the respective laser heads. As can be seen from FIG. 7, in the case of such discrete working regions of a respective laser head, visible transitions, or irregularities 252a, 252b, 252c, 252d of the engraved structure 250 can be created between the adjacent regions 251a, 251c and 251b, 251d which have been processed by different laser heads, as well as between the adjacent regions 251a, 251b and 251c, 251d which have in each case been processed by the same laser head but at different displacement positions of the worktable, these transitions or irregularities to be prevented according to the invention.

Illustrated in FIG. 8 is a view from above of four exemplary grooves 265a, 265b, 265c, 265d of the structure 260 engraved in the wood veneer of the cover layer 11 of the composite material 10, which exemplary grooves 265a, 265b, 265c, 265d extend, for example, beyond a first overlapping portion U1 between two regions B1, B2 of the composite material 10 generated by different laser heads 183a, 183b of the laser engraving device 200 according to FIGS. 2 to 6. At least parts of the structure 260 herein have thus been engraved in the wood veneer of the cover layer 11 in the form of grooves 265a, 265b, 265c, 265d that extend at least in part between two adjacent regions B1, B2 of the composite material 10 that are assigned to a respective laser head 183a, 183b, wherein the initial points and/or final points 261, 262, 263, 264 of the grooves 265a, 265b, 265c, 265d generated by means of the laser beam 181a, 181b of the one laser head 183a, 183b, and the final points and/or initial points 261, 262, 263, 264 of the grooves 265a, 265b, 265c, 265d generated by means of the laser beam 181b, 181a of the other laser head 183b, 183a in the first overlapping portion U1 have been randomly established, i.e. the grooves 265a, 265b, 265c, 265d do not begin or end at the border of a respective discrete working region of a respective laser head 183a, 183b, as is the case in FIG. 7, but the initial points and/or final points 261, 262, 263, 264 of the grooves 265a, 265b, 265c, 265d within the first overlapping region U1 have been established randomly and consequently in a mutually offset manner so as to “blur” the transition between the working regions 182a, 182b of the laser heads 183a, 183b (cf. also FIG. 6).

In an analogous manner, it can be expediently be provided that the structure 260 is engraved in the wood veneer of the cover layer 11 in the form of grooves 265a, 265b, 265c, 265d that extend at least in part between two adjacent regions B1, B2 of the composite material 10 that are in each case assigned to the same laser head 183a, 183b, wherein the initial points and/or final points 261, 262, 263, 264 of the grooves 265a, 265b, 265c, 265d generated by means of the laser beam 181a, 181b of the respective laser head 183a, 183b before a displacement step of the worktable 202, and the final points and/or initial points 261, 262, 263, 264 of the grooves 265a, 265b, 265c, 265d generated by means of the laser beam 181a, 181b of the respective laser head 183a, 183b after a displacement step of the worktable 202 in the second overlapping portion U2 are randomly established.

If desired, it can finally also be provided that the wood veneer of the cover layer 11 of the composite material 10 after the above-described operative step of laser engraving is provided with a lacquer layer, which can be performed either manually or in particular likewise in an automated manner in that the completely engraved composite bodies 10, e.g. by means of the worktable 202, are fed piece-by-piece or portion-by-portion to a painting apparatus disposed downstream of the laser processing region 203 of the laser engraving device 200.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for producing a planar resilient composite material that has a carrier layer of a resilient material, in particular in the form of a textile material, and a cover layer of wood veneer which is connected to the carrier layer and is more rigid in comparison to the carrier layer, wherein a structure configured in a form of a plurality of grooves is engraved in the wood veneer of the cover layer via laser engraving, so as to increase a resilience of the wood veneer of the cover layer, the method comprising:
establishing a structure to be engraved in the wood veneer of the cover layer;
importing the structure into a control apparatus of a laser engraving device specified in programming terms;
arranging the composite material on a worktable of the laser engraving device such that the wood veneer of the cover layer of the composite material is located on a side facing away from the worktable;
activating at least one laser head of the laser engraving device that is connected to the control apparatus; and
engraving the structure in the wood veneer of the cover layer of the composite material via the laser beam generated by the laser head,
wherein at least two laser heads of the laser engraving device that are connected to the control apparatus are activated so as to, via the laser beam of a respective laser head, engrave the structure substantially simultaneously in adjacent regions of the wood veneer of the cover layer of the composite material that are assigned to a respective laser head,
wherein the laser heads are controlled such that in a first overlapping portion of the adjacent regions of the composite material the structure is engraved in the wood veneer of the cover layer randomly in part by the laser beam of the one laser head and in part by the laser beam of the other laser head.

2. The method according to claim 1, wherein the structure is engraved in the wood veneer of the cover layer in the form of grooves, which at least in part extend between two adjacent regions of the composite material that are assigned to a respective laser head, wherein the initial points and/or final points of the grooves generated by the laser beam of the one laser head and the final points and/or initial points of the grooves generated by the laser beam of the other laser head in the first overlapping portion are randomly established.

3. The method according to claim 1, wherein the structure engraved in the wood veneer of the cover layer in the form of a plurality of grooves is engraved such that the carrier layer remains substantially intact, and wherein the wood veneer of the cover layer is at least in part or substantially completely cut through.

4. The method according to claim 1, wherein the worktable of the laser engraving device with the composite material is displaced past the laser heads in a substantially continuous or semi-continuous manner so as to engrave the structure successively in adjacent regions of the wood veneer of the cover layer, and wherein the displacement direction of the worktable is chosen so as to be substantially parallel to the direction of extent of the first overlapping portion between the laser heads.

5. The method according to claim 4, wherein the displacement of the worktable is synchronized with the laser heads in that a drive of the worktable that is connected to the control apparatus of the laser heads displaces the worktable as a function of the processing state of the structure.

6. The method according to claim 4, wherein the worktable comprises:
a slide that is adapted to receive the composite material and is driven by a motorized drive and is guided past the laser heads along a guide (201); or
a belt conveyor, in particular in the form of a revolving carrier belt, which is adapted to receive the composite material and is driven by a motorized drive and is guided past the laser heads; or
a roller track that has a plurality of rolls or rollers disposed in parallel and is adapted to receive the composite material, at least some of the rolls or rollers being rotationally driven by a motorized drive so as to guide the composite material past the laser heads.

7. The method according to claim 4, wherein a respective laser head is controlled in such a manner that, in a second overlapping portion, extending substantially perpendicularly to the displacement direction of the worktable of adjacent regions of the composite material that are in each case assigned to the same laser head, the structure is engraved in the wood veneer of the cover layer by the laser beam of the respective laser head randomly in part before a displacement step of the worktable and in part after a displacement step of the worktable.

8. The method according to claim 7, wherein the structure is engraved in the wood veneer of the cover layer in the form of grooves which at least in part extend between two adjacent regions of the composite material that are in each case assigned to the same laser head, wherein initial points and/or final points of the grooves generated by the laser beam of the respective laser head before a displacement step of the worktable, and the final points and/or initial points of the grooves generated by the laser beam of the respective laser head after a displacement step of the worktable in the second overlapping portion are randomly established.

9. The method according to claim 1, wherein the composite material, at least while the structure is being engraved in the wood veneer of the cover layer, is suctioned to the worktable.

10. The method according to claim 1, wherein the laser engraving machine has at least two stationary galvanometric laser heads that have at least one mirror and/or lens connected to the control apparatus, wherein the laser heads via the control apparatus are controlled such that the mirrors and/or lenses are displaced in a manner corresponding to the structure to be engraved in the wood veneer of the cover layer.

11. The method according to claim 1, wherein the laser heads are disposed at a spacing of between 10 cm and 150 cm, between 30 cm and 130 cm, or between 50 cm and 110 cm from the surface of the wood veneer of the cover layer of the composite material.

12. The method according to claim 1, wherein the wood veneer of the cover layer after laser engraving is provided with a lacquer layer.
